(19) United States
(12) Patent Application Publication
(10) Pub. No.: US 2026/0003515 A1
(43) Pub. Date: Jan. 1, 2026

(54) MEMORY INTERFACE CIRCUITS INCLUDING ENCRYPT/DECRYPT CIRCUITS TO RE-ENCRYPT ENCRYPTED DATA BLOCKS IN A MEMORY CIRCUIT AND RELATED METHODS

(71) Applicant: Microsoft Technology Licensing, LLC, Redmond, WA (US)

(72) Inventors: Jitendra LULLA, Bangalore (IN); Raymond Marcelino Manese LIM, Scarsdale, NY (US); Wael NOUREDDINE, Los Altos, CA (US); Eric SWARTZENDRUBER, Austin, TX (US); Charles Edward GRAY, San Francisco, CA (US); Dilipkumar ADIKESAVAN, San Ramon, CA (US)

(21) Appl. No.: 18/755,093

(22) Filed: Jun. 26, 2024

(51) Int. Cl. G06F 3/06

(52) U.S. Cl. CPC G06F 3/0622; G06F 3/0655; G06F 3/0679

(57) ABSTRACT

An exemplary memory interface circuit disclosed herein re-encrypts data in an encrypted data block in a memory circuit to further protect the data. In particular, the memory interface circuit reads an encrypted data block from the memory circuit and decrypts the encrypted data block using a first key that was previously used to encrypt the block of data. Then, the memory interface circuit encrypts the data again using a second key before storing the re-encrypted data back into the memory circuit. In some examples, the memory interface circuit includes a re-encryption circuit that includes secure configuration registers to control occasional re-encryption of the encrypted data in an effort to evade detection of the encryption key. In some examples, the time between re-encryptions may be adjusted in response to a frequency of memory accesses to the memory circuit.

### FIELD OF THE DISCLOSURE

The technology of the disclosure relates, in general, to a memory interface circuit in a processor-based system and, more particularly, to a memory interface providing data security during memory accesses.

### BACKGROUND

The focus on protecting the confidential data of individuals, businesses, organizations, and governments has increased as efforts to breach security in processor-based systems are increasing in frequency and in the complexity of their methods. Known methods of unauthorized data access include attempts to use software (e.g., hacking) to gain unauthorized access to a computing system through a network. Alternatively, when physical access to a computer is available, other methods may be employed, such as directly monitoring memory interfaces (e.g., buses) to a system memory in an effort to detect the data being read from and written to the system memory. In one such method, data may be identified by monitoring power consumption in an interface to the system memory. To increase protection from such attacks, data may be encrypted using a key before the data is stored in the memory and decrypted using the key when it is read back from the memory. However, protecting data by encryption relies on the key being known only to the memory interface circuit that performs the encryption and decryption. Thus, some data security methods are directed to protecting the data by protecting the encryption key.

### SUMMARY

Exemplary aspects disclosed herein include memory interface circuits, including encrypt/decrypt circuits to re-encrypt encrypted data in memory circuits. Exemplary methods of re-encrypting encrypted data blocks in a memory circuit are also disclosed. In a processor-based system, instructions executing in a processor or processing circuit may store sensitive or confidential data in a memory circuit. Efforts to obtain the sensitive data may include monitoring a memory interface between the memory circuit and a memory interface circuit that executes the memory transactions for the processing circuit. To protect against such monitoring, the memory interface circuit employs an encryption circuit to encrypt data received from the processing circuit, before it is stored in the memory circuit, and decrypt the data read back from the memory circuit, before it is forwarded to the processing circuit. However, through continued use of a same encryption key, it may be possible to determine the encryption key from the encrypted data detected on the memory interface.

An exemplary memory interface circuit disclosed herein re-encrypts data in an encrypted data block in a memory circuit to further protect the data. In particular, the memory interface circuit reads an encrypted data block from the memory circuit and decrypts the encrypted data block using a first key that was previously used to encrypt the block of data. Then, the memory interface circuit encrypts the data again using a second key before storing the re-encrypted data back into the memory circuit. In some examples, the memory interface circuit includes a re-encryption circuit that includes secure configuration registers to control occasional re-encryption of the encrypted data, in an effort to evade detection of the encryption key. In some examples, the time between re-encryptions may be adjusted in response to a frequency of memory accesses to the memory circuit.

In one exemplary aspect, a memory interface circuit, including a first interface configured to couple to a processing circuit, a second interface configured to couple to a memory circuit, and an encrypt/decrypt circuit, is disclosed. The memory interface circuit is configured to encrypt data stored in the memory circuit in response to a memory write transaction from the processing circuit, decrypt encrypted data read from the memory circuit in response to a memory read transaction from the processing circuit and re-encrypt first data in a first encrypted data block stored in the memory circuit. The re-encrypt includes reading the first encrypted data block comprising a first number of cache lines from the memory circuit; decrypting, in the encrypt/decrypt circuit, the first encrypted data block based on a first key to recover the first data; encrypting, in the encrypt/decrypt circuit, the first data based on a second key to generate a second encrypted data block comprising the first number of cache lines; and writing the second encrypted data block to the memory circuit.

In another exemplary aspect, a processor-based system including a memory interface circuit, at least one processing circuit, an encrypt/decrypt circuit, a memory circuit, and a re-encryption circuit is disclosed. The re-encryption circuit includes a first interface configured to couple to the at least one data processing circuit and a second interface configured to couple to the memory circuit. The memory interface circuit is configured to encrypt data stored in the memory circuit in response to a memory write transaction from the at least one processing circuit, decrypt encrypted data read from the memory circuit in response to a memory read transaction from the at least one processing circuit and re-encrypt first data in a first encrypted data block stored in the memory circuit. The re-encrypt includes reading the first encrypted data block comprising a first number of cache lines from the memory circuit; decrypting, in the encrypt/decrypt circuit, the first encrypted data block based on a first key to recover the first data; encrypting, in the encrypt/decrypt circuit, the first data based on a second key to generate a second encrypted data block comprising the first number of cache lines; and writing the second encrypted data block to the memory circuit.

In another exemplary aspect, a method of an interface circuit to re-encrypt first data in a first encrypted data block in a memory circuit is disclosed. The method includes reading the first encrypted data block comprising a first number of cache lines from the memory circuit, decrypting the first encrypted data block based on a first key to recover the first data, encrypting the first data based on a second key to generate a second encrypted data block comprising the first number of cache lines, and writing the second encrypted data block to the memory circuit.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic diagram illustrating a system including a memory interface circuit configured to access memory circuits in response to memory access transactions from at least one processing circuit and a secure processor configured to provide a secure enclave in which encryption keys can be securely generated and managed;

FIG. 2 is a schematic diagram of the memory interface circuit in FIG. 1, including interfaces to at least one processing circuit, interfaces to memory circuits, and memory access circuits that include encrypt/decrypt circuits;

FIG. 3 is a schematic diagram of an exemplary queue circuit and encrypt/decrypt circuit similar to those in FIG. 2 but including exemplary secure configuration registers coupled to the secure interface and the secure processor in FIG. 1;

FIG. 4 is a state diagram of states of data encryption in the encryption circuit under the control of the secure processor in FIG. 1;

FIG. 5 is a flow chart of a method of re-encrypting, using a second key, data in a first encrypted data block encrypted using a first key in the memory interface circuit in FIG. 2; and

FIG. 6 is a block diagram of an exemplary processor-based system that comprises processing circuits included on an IC chip, including a memory interface circuit coupled to the processing circuits and a memory circuit, and configured to re-encrypt, using a second key, data in a first encrypted data block encrypted using a first key.

### DETAILED DESCRIPTION

With reference to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Exemplary aspects disclosed herein include memory interface circuits, including encrypt/decrypt circuits to re-encrypt encrypted data in memory circuits. An exemplary memory interface circuit disclosed herein re-encrypts data in an encrypted data block in a memory circuit to further protect the data. In particular, the memory interface circuit reads an encrypted data block from the memory circuit and decrypts the encrypted data block using a first key that was previously used to encrypt the block of data. Then, the memory interface circuit encrypts the data again using a second key before storing the re-encrypted data back into the memory circuit. In some examples, the memory interface circuit includes a re-encryption circuit that includes secure configuration registers to control occasional re-encryption of the encrypted data in an effort to evade detection of the encryption key. In some examples, the time between re-encryptions may be adjusted in response to a frequency of memory accesses to the memory circuit.

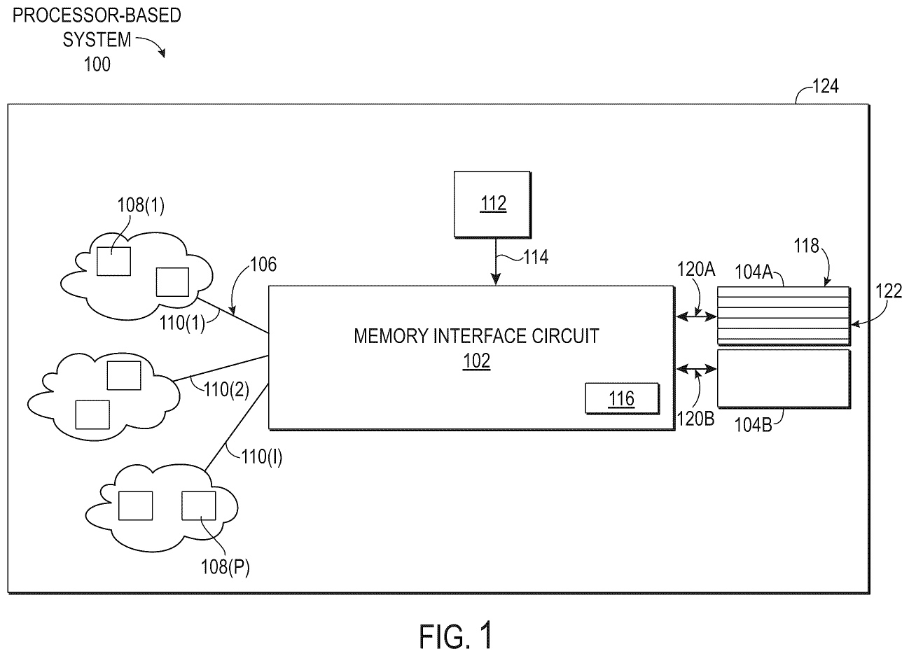

FIG. 1 is a schematic diagram of an exemplary processor-based system 100 including a memory interface circuit 102 configured to access memory circuits 104A, 104B in response to memory access transactions 106 received from at least one processing circuit 108(1)-108(P) on system interfaces 110(1)-110(I). The at least one processing circuit 108(1)-108(P) may include any number (P) of processing circuits that may be coupled to the memory interface circuit 102 through one of the system interfaces 110(1)-110(1), which may be mesh networks, for example. The memory interface circuit 102 may also be securely coupled to a secure processor 112 by a secure interface 114.

The memory interface circuit 102 is configured to encrypt data 116 received from at least one processing circuit 108(1)-108(P) in a memory write operation and generate encrypted data 118 that is written to the memory circuits 104A, 104B. The memory interface circuit 102 is also configured to decrypt the encrypted data 118 read back from the memory circuits 104A, 104B to regenerate the data 116 before providing the data 116 to the requesting at least one processing circuit 108(1)-108(P). Even though the data 116 is encrypted before being transferred over to the memory circuits 104A, 104B on respective memory interfaces 120A, 120B, additional protection can be provided against monitoring of the memory interfaces 120A, 120B by occasionally changing a key used to generate the encrypted data 118 from the data 116. Thus, the secure processor 112 may securely manage decryption and re-encryption in the memory interface circuit 102 of data 116 stored as encrypted data 118 in the memory circuits 104A, 104B.

The memory circuits 104A, 104B may be dynamic random-access memory (DRAM), double-data rate (DDR) memory, or another type of memory circuits or chips coupled to the memory interface circuit 102 by memory interfaces 120A, 120B, respectively. Data 116 stored in the memory circuits 104A, 104B may be accessed and organized in units of cache lines 122, where a cache line 122 comprises a number of bytes that may be determined based on a cache size. In some examples, a cache line may be 32, 64, or 128 bytes, but the cache lines 122 may include any number of bytes.

In some examples, the memory circuits 104A, 104B may be disposed in chiplets where the processor-based system 100 is disposed on a substrate 124. In other examples, the memory circuits 104A, 104B may be disposed on a package substrate or separate package component separate from the memory interface circuit 102. Attempts to determine the data being written to and read from the memory circuits 104A, 104B may include monitoring the memory interfaces 120A, 120B.

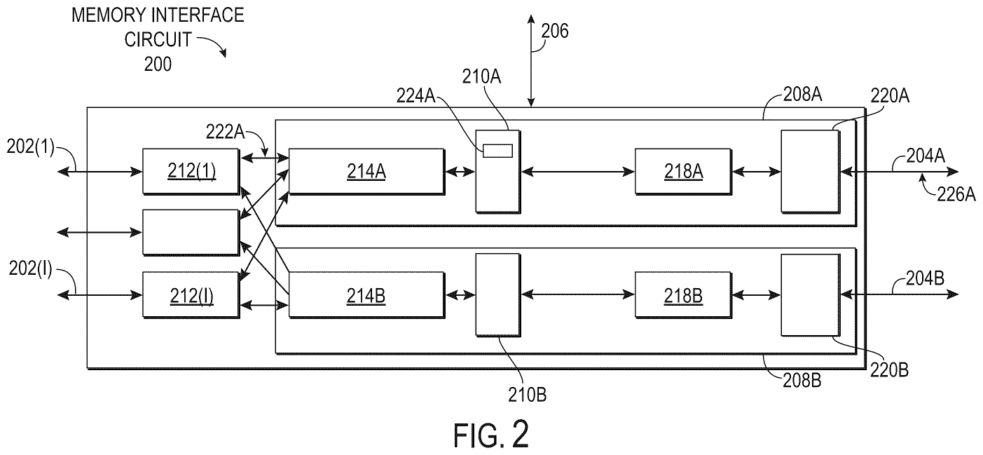

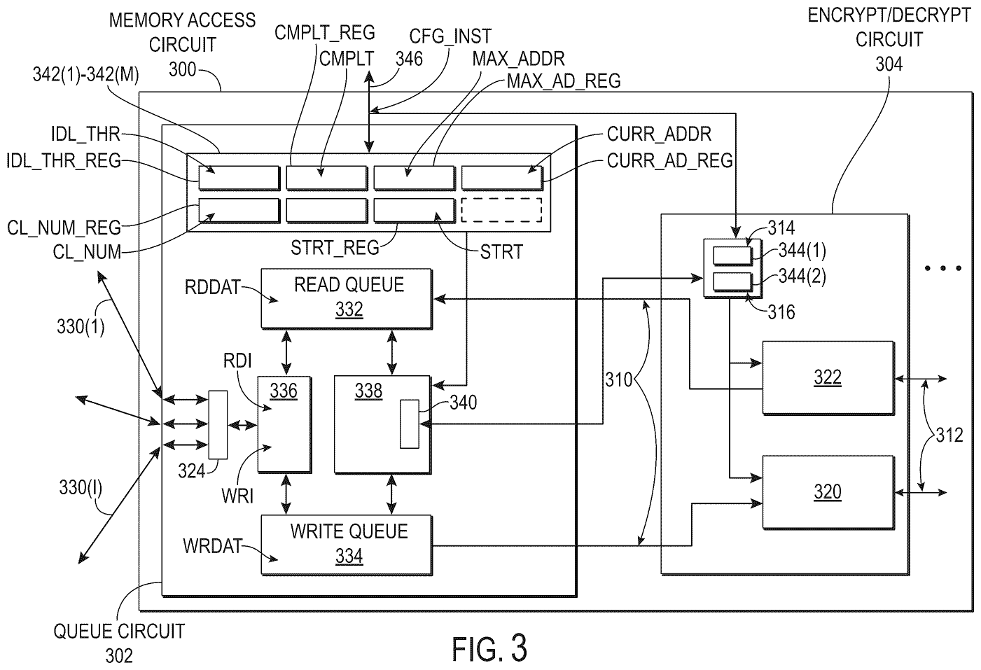

FIG. 2 is a schematic diagram of a memory interface circuit 200, which may be the memory interface circuit 102 in FIG. 1, including system interfaces 202(1)-202(I) that are configured to couple to at least one processing circuit (not shown), such as the processing circuits 108(1)-108(P), and memory interfaces 204A, 204B configured to couple to memory circuits (not shown), such as the memory circuits 104A, 104B in FIG. 1. The memory interface circuit 200 also includes a secure interface 206, which may be the secure interface 114, the details of which are described below with reference to FIG. 3. The memory interface circuit 102 includes two memory access circuits 208A, 208B that handle memory accesses to the respective memory interfaces 204A, 204B. The memory access circuits 208A, 208B include encrypt/decrypt circuits 210A, 210B configured to encrypt data being written to the memory circuits 104A, 104B of FIG. 1 and decrypt encrypted data being read back from the memory circuits 104A, 104B.

As noted, the memory access circuits 208A, 208B correspond, respectively, to the memory interfaces 204A, 204B in the processor-based system 100, but the memory interface circuit 200 may include any number of memory access circuits to correspond to a number of memory interfaces. In this example, the memory interface circuit 200 is coupled to three (3) system interfaces 202(1)-202(I), where I=3, and each of the memory access circuits 208A, 208B may be coupled to each of the memory interfaces 204A, 204B through system interface circuits 212(1)-212(I). The memory access circuit 208A may execute memory access transactions (e.g., read or write transactions) from any of the system interfaces 202(1)-202(I) directed to memory addresses of the memory circuit (e.g., 104A) coupled to the memory interface 204A. The memory access circuit 208B may execute memory access transactions from any of the system interfaces 202(1)-202(I) directed to memory addresses of the memory circuit (e.g., 104B) coupled to the memory interface 204B.

The encrypt/decrypt circuits 210A, 210B are provided in the memory access circuits 208A, 208B to provide protection for the data stored in the memory circuits 104A, 104B. In addition to the encrypt/decrypt circuits 210A, 210B, the memory access circuits 208A, 208B include queue circuits 214A, 214B that queue or buffer data being transferred between the system interfaces 202(0)-202(I) and the corresponding memory circuits 104A, 104B. The memory access circuits 208A, 208B also include memory buffer circuits 218A, 218B, respectively, to provide data buffering between the encrypt/decrypt circuits 210A, 210B, and the memory interfaces 204A, 204B. Memory interface control circuits 220A, 220B, provide the physical interfaces to the memory interfaces 204A, 204B, respectively.

As noted above, the encrypt/decrypt circuits 210A, 210B provide encryption and decryption of data. In particular, data 222A being written to the memory circuit 104A in response to a write transaction, for example, is encrypted using a key 224A. In response to receiving a block of the data 222A and the key 224A, the encrypt/decrypt circuit 210A executes an encryption algorithm to generate an encrypted data block 226A that is written to the memory circuit 104A over the memory interface 204A. In response to a read transaction, the encrypt/decrypt circuit 210A reads the encrypted data block 226A from the memory circuit 104A, decrypts the encrypted data block 226A to recover the data 222A, and provides the data 222A to the queue circuit 214A. Having the data 222A encrypted in the encrypted data block 226A when it is transferred across the memory interface 204A, to and from the memory circuit 104A provides increased protection from detection of the data 222A by any form of monitoring of the memory interface 204A. However, if the data 222A continues to be encrypted by the same key 224A for an extended period of time, it may be possible for the key 224A to be determined from the encrypted data block 226A and used to recover the data 222A, thereby breaching the data security of the processor-based system 100 in FIG. 1.

FIG. 3 is a schematic diagram of an exemplary memory access circuit 300 that may be either of the memory access circuits 208A or 208B in FIG. 2 coupled to a corresponding one of the memory circuits 104A and 104B in FIG. 1. Operation of the memory access circuit 300 is described in the context of the memory access circuit 208A in FIG. 2 coupled to the memory circuit 104A in FIG. 1, as an example. In addition to being configured to perform functions similar to the memory access circuit 208A, the memory access circuit 300 includes a queue circuit 302 and an encrypt/decrypt circuit 304 that may be configured to re-encrypt data 310 in an encrypted data block 312 stored in the memory circuit 104A. Re-encrypting the data 310 includes reading the encrypted data block 312, which comprises a number X of cache lines 120, from the memory circuit 104A, and decrypting, in the encrypt/decrypt circuit 304, the encrypted data block 312 using a first key 314 that was used to encrypt the encrypted data block 312. In this example, the first key 314 was previously employed to encrypt the data 310 to generate the encrypted data block 312 before it was stored in the memory circuit 104A. The re-encrypting further includes encrypting, in the encrypt/decrypt circuit 304, the data 310 based on a second key 316 to generate a second encrypted data block 312 comprising the same number X of cache lines 120, and writing the second block 312 of encrypted data to the memory circuit 104A. As noted above, re-encrypting data 310 from the first encrypted data block 312 based on the first key 314 to the second encrypted data block 312 based on the second key 316 reduces the vulnerability of the data 310 to detection. That is, by using the first key 314 for a limited period of time, the opportunity for the first key 314 to be determined from the monitored data and used to decrypt future data is also limited.

Before providing a detailed description of the re-encryption of the data 310, features of the queue circuit 302 and the encryption/decryption circuit 304 are first provided. The encrypt/decrypt circuit 304 includes an encrypt circuit 320 to encrypt the data 310 written to the memory circuit 104A in response to memory write transactions from the at least one processing circuit 108(1)-108(I) in FIG. 1. As noted above, the data 310 is encrypted into the encrypted data block 312 before being transferred to the memory circuit 104A in an effort to avoid detection of the data 310 as it is transferred to the memory circuit 104A on the memory interface 204A. The data 310 in the encrypted data block 312 remains protected in this manner as it is transferred from the memory circuit 104A back to the memory access circuit 300 in response to a memory read transaction. The encrypt/decrypt circuit 304 includes a decrypt circuit 322 to decrypt the data block 312 of encrypted data received from the memory circuit 104A before the data 310 is provided to the at least one processing circuit 108(1)-108(I) that requested the data 310.

The queue circuit 302 includes a multi-bus interface 324 coupled to system interfaces 330(1)-330(I), which correspond to the system interfaces 202(1)-202(I) in FIG. 2. The multi-bus interface 324 may receive memory access transactions and/or data 310 from any of the system interfaces 330(0)-330(I). The queue circuit 302 also includes a read queue 332, a write queue 334, a queue manager 336, and a memory scheduler 338.

In response to a memory write transaction WRI received from any of the system interfaces 330(0)-330(I), the multi-bus interface 324 may forward the memory write transaction WRI to the queue manager 336 and forward the corresponding write data WRDAT to the write queue 334. The write data WRDAT may be the data 310 discussed above. In response to the write transaction WRI, the queue manager 336 controls the memory scheduler 338 to initiate a write operation to the memory circuit 104A and move data WRDAT from the write queue 334 to the encrypt/decrypt circuit 304 for encryption using the first key 314. From a block of the data 310, the encrypt/decrypt circuit 304 generates the encrypted data block 312 that is stored in the memory circuit 104A.

In response to a memory read transaction RDI received from any of the system interfaces 330(1)-330(I), the multi-bus interface 324 may forward the memory read transaction RDI to the queue manager 336, which controls the memory scheduler 338 to initiate a read operation to the memory circuit 104A. In response, the encrypted data block 312 (at a memory address designated by the read transaction RDI) is read back from the memory circuit 104A and provided to the encrypt/decrypt circuit 304, where the encrypted data block 312 is decrypted to restore the data 310. The data 310 is requested data RDDAT requested in the read transaction. The requested data RDDAT is received from the encrypt/decrypt circuit 304 and stored in the read queue 332. The queue manager 336 and the multi-bus interface 324 may control the transfer of the read data RDDAT from the read queue 332 to an appropriate one of the system interfaces 330(1)-330(I), which may be the one from which the read transaction RDI was received.

The write queue 334 is a “write buffer.” In some cases, the write data WRDAT being stored into the write queue 334 and the read data RDDAT in the read queue 332 may be associated with a same memory address. As a result, there can be a read/write ordering hazard resulting in stale data being returned in response to the read transaction RDI. For example, when a received read transaction RDI is requesting data from a same memory address that is the target of a pending write transaction WRI (e.g., currently waiting in the write queue 334), the read transaction RDI will not actually be queued in the read queue 332. Instead, the read transaction RDI will not enter the read queue 332 and will use the content in the write buffer 334 for the target address for the reply, bypassing the entire memory access path. In some examples, the write queue 334 will only contain one entry for a write address, such that if multiple writes to the same address are received and stored in the write queue 334 while waiting to be completed, the data content of an older entry will be updated according to the most recent data written to the target address.

The memory scheduler 338 couples the queue circuit 302 to the encrypt/decrypt circuit 304. In an exemplary aspect, memory scheduler 338 includes a re-encryption circuit 340 that controls re-encryption of the data 310 stored in the memory circuit 104A based on a plurality of secure configuration registers (“configuration registers”) 342(1)-342(M) and key registers 344(1), 344(2). The secure configuration registers 342(0)-342(M) and key registers 344(1), 344(2) may be programmed or configured by the secure processor 112 in FIG. 1 providing configuration instructions CFG_INST over a secure interface 346, which may be the secure interface 206 in FIG. 2 or the secure interface 114 in FIG. 1. In this example, the secure configuration registers 342(1)-342(M) are included in the queue circuit 302, and the key registers 344(1), 344(2) are included in the encrypt/decrypt circuit 304, but the memory access circuit 300 is not limited to such arrangement.

The secure interface 346 is configured to receive configuration instructions CFG_INST directed to the secure configuration registers 342(1)-342(M) and determine, for each configuration instruction CFG_INST received, whether a source of the configuration instruction CFG_INST has authorization to access the plurality of secure configuration registers 342(1)-342(M). In response to determining the source of the configuration instruction CFG_INST has the authorization, the secure interface 346 is configured to access the plurality of secure configuration registers 342(1)-342(M) according to the configuration instruction CFG_INST. For example, if the secure processor 112 is authorized to configure the secure configuration registers 342(1)-342(M), and the secure processor 112 is determined to be the source of the configuration instruction CFG_INST attempting to access the secure configuration registers 342(1)-342(M), the access will be executed according to the configuration instruction CFG_INST. In this regard, the secure configuration registers 342(1)-342(M) may be written to or programmed with information used by the re-encryption circuit 340 to control the re-encryption of data 310 stored in the memory circuit 104A. In the examples disclosed herein, the secure processor 112 is the only example of a source of the configuration instructions CFG_INST that is authorized to access the secure configuration registers 342(1)-342(M), but others may be configured. For example, the secure processor 112 may configure the re-encryption circuit to recognize other authorized secure sources of the configuration instructions CFG_INST.

In some examples, the data 310 stored in one or more configurable ranges of memory addresses in the memory circuit 104A is encrypted while another range or ranges of memory addresses are not encrypted. Ranges of memory addresses in which data 310 is encrypted may include confidential or high security data, for example. Thus, the re-encryption circuit 340 may be configured to re-encrypt only the encrypted data blocks 312 stored in the one or more ranges of memory addresses in which data 310 is encrypted.

The re-encryption may be performed one encrypted data block 312 at a time to reduce or avoid performance delays of memory access transactions. The encrypted data block 312 comprises a configurable number of the cache lines 122 in FIG. 1. One of the secure configuration registers 342(1)-342(M) may be configured to store a number CL_NUM indicating the number of cache lines 122 included in the encrypted data block 312. The secure configuration registers 342(1)-342(M) may include a cache line number register CL_NUM_REG configured to store the number CL_NUM. The re-encryption circuit 340 may pause the re-encryption process between encrypted data blocks 312 to allow some memory access transactions to be executed.

In some examples, the re-encryption circuit 340 is configured to read the first number 348 of cache lines 122 before writing the second encrypted data block 312 to the memory circuit 104A. The number CL_NUM of cache lines 122 of an encrypted data block 312 may be stored in sequential memory addresses in the memory circuit 104A. When the number CL_NUM stored in the secure configuration registers 342(1)-342(M) is “32”, indicating that the first encrypted data block 312 comprises 32 cache lines in sequential memory addresses, the re-encryption circuit 340 is configured to read 32 cache lines 122 in sequence from the memory circuit 104A, decrypting each cache line one at a time and storing them in the read queue 332 and/or write queue 334 before re-encrypting the data 310 using the second key 316 and writing a second encrypted data block 312 back to the memory circuit 104A. The re-encryption circuit 340 may pause after completion of the re-encryption of each encrypted data block 312 to allow execution of memory access transactions.

The re-encryption circuit 340 has a need to keep track of the memory address of the cache line 122 in an encrypted data block 312 that is currently being re-encrypted. For this reason, the secure configuration registers 342(1)-342(M) may be further configured to store a current memory address CURR_ADDR of a cache line 122 currently being or most recently read from the first encrypted data block 312 in the memory 104A circuit. The re-encryption circuit 340 may be configured to refer to the current memory address CURR_ADDR to determine a memory address of a next one of the cache lines 122 of the first encrypted data block 312 to be read and may increment the current memory address CURR_ADDR each time a cache line 122 has been read. In this regard, the secure configuration registers 342(1)-342(M) may include a current address register CUR_AD_REG for storing the current memory address CURR_ADDR of a cache line 122 currently being or most recently read from the memory circuit 104A.

In a first range of memory addresses of the memory circuit 104A in which data 310 is stored in encrypted form, a plurality of encrypted data blocks may be stored, and the re-encryption circuit 340 may re-encrypt each of the encrypted data blocks 312 in order of increasing memory addresses, for example. The re-encryption circuit 340 may determine when the re-encryption process is completed based on an indication in the secure configuration registers 342(1)-342(M) of a maximum memory address MAX_ADDR (e.g., highest numerical memory address) in the range of memory addresses in which the data 310 is encrypted. In this regard, the secure configuration registers 342(1)-342(M) may include a maximum address register MAX_AD_REG storing the maximum memory address MAX_ADDR of a cache line 122 in the range of memory addresses in which the data 310 is encrypted. In response to re-encrypting the cache line 122 at the maximum memory address MAX_ADDR, the secure configuration registers 342(1)-342(M) may also store a complete indication CMPLT that the re-encryption of all the encrypted data blocks 312 in the memory circuit 104A is complete. In this regard, the secure configuration registers 342(1)-342(M) may include a re-encryption complete register CMPLT_REG to store the indication CMPLT that the re-encryption of all the encrypted data blocks 312 in the memory circuit 104A is complete.

The re-encryption circuit 340 may execute a process of re-encryption of the encrypted data blocks 312 in the memory circuit 104A periodically or occasionally. In some examples, the secure configuration registers 342(1)-342(M) are configured to store a start indication STRT indicating, to the re-encryption circuit 340, to start re-encrypting the first data 310 in the encrypted data blocks 312 in the memory circuit 104A. In this regard, the secure configuration registers 342(1)-342(M) may include a start register STRT_REG to store the start indication STRT. The start register STRT_REG may be programmed by the secure processor 112.

Periods of reduced activity on the memory access circuit 300 may make the data 310 and corresponding key (i.e., the first key 314 or second key 316) more susceptible to detection. In some examples, the secure configuration registers 342(1)-342(M) may store a threshold number IDL_THR of cycles in which the memory access circuit 300 may be idle, indicating an idle time between receiving consecutive memory access transactions. The secure configuration registers 342(1)-342(M) may include a threshold number of registers IDL_THR_REG that store the threshold number IDL_THR. The re-encryption circuit 340 or the secure processor 112 may count the number of idle cycles and compare the count to the threshold number IDL_THR and may turn on or write the start indication STRT in the start register STRT_REG if the count reaches the threshold number IDL_THR. Idle cycles may be detected in a variety of ways, and the present disclosure is not intended to be limited in this regard. In some examples, in response to detection of idle cycles, the secure processor 112 may transmit a second configuration instruction to write the start indication STRT in the start register within a time window of two (2) minutes to 20 minutes, for example, after a first configuration instruction to write the start indication STRT in the start register STRT_REG. Longer or shorter periods of idle cycles may be employed.

The re-encryption circuit 340 employs the first key 314, which was used to encrypt the encrypted data blocks 312 in the memory circuit 104A, to decrypt the encrypted data blocks 312, and employs a second key 316 to encrypt the data 310 to generate second encrypted data blocks 312. The first key register 344(1) is configured to store the first key 314 and the second key register 344(2) is configured to store the second key 316. After the re-encrypting is completed, all the encrypted data blocks 312 stored in the memory circuit 104A are encrypted based on the second key 316 and none are based on the first key 314. In response to an indication that re-encrypting the encrypted data blocks is complete, the re-encryption circuit 340 is configured to update the first key register 344(1) to store an updated first key 314. In this regard, in response to the indication that re-encrypting the encrypted data blocks 312 is complete, the secure processor 112 in FIG. 1 may provide the updated first key 314 to the re-encryption circuit 340 on the secure interface 346, and the re-encryption circuit 340 updates the first key register 344(1). After a next re-encrypting process is complete, all the encrypted data blocks 312 will be encrypted using the updated first key 314, at which time the second key register 344(2) will be updated to store an updated second key 316. The re-encrypting process continues switching between the first and second keys 314 and 316 and updating one of the first and second key registers 344(1), 344(2) that stores a key that is no longer used. The first key 314 and the second key 316 stored in the first and second key registers 344(1), 344(2) may be generated by a key derivation function, which may reside in the secure processor 112, or in the encrypt/decrypt circuit 304.

As noted above, updates to the secure configuration registers 342(1)-342(M) and key registers 344(1), 344(2) may be performed by the re-encryption circuit 340, which manages the secure interface 346, in response to the configuration instructions CFG_INST received from the secure processor 112 as shown in FIG. 1. In this regard, the secure processor 112 may provide configuration instructions CFG_INST to the re-encryption circuit 340 based on a state of the re-encrypting process.

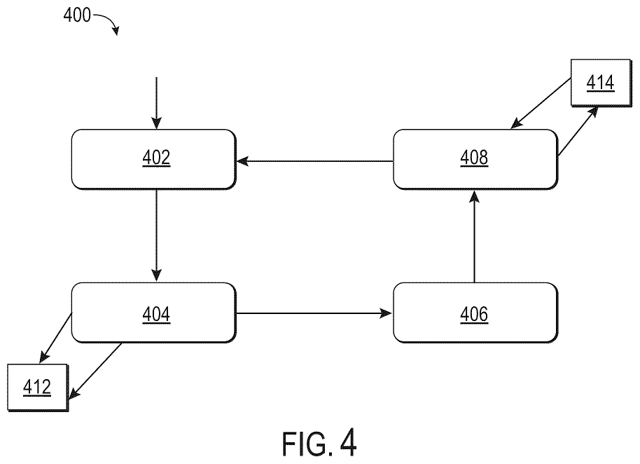

FIG. 4 is a state diagram 400 of states 402, 404, 406, and 408 of re-encryption in the re-encryption circuit under the control of the secure processor 112 in FIG. 1. State 402 is defined as a condition in which re-encryption of the encrypted data blocks 312 in the memory circuit 104A has been started, such that some of the encrypted data blocks 312 in the memory circuit 104A that were previously encrypted using the first key 314 in the first key register 344(1) have been encrypted using the second key 316 in the second key registers 344(2). State 404 is defined as a condition in which all the encrypted data blocks 312 have been encrypted using the second key 316, and none are encrypted using the first key 314. In state 404, the secure processor 112 enters and exits a sub-state 412, in which the first key register 344(1) is updated.

State 406 is defined as a condition in which re-encryption of the encrypted data blocks 312 in the memory circuit 104A has been started, such that some of the encrypted data blocks 312 that were previously encrypted using the second key 316 in the second key register 344(2) have been encrypted using the updated first key 314 in the first key register 344(1). State 408 is defined as a condition in which all the encrypted data blocks 312 have been encrypted using the updated first key 314, and none are encrypted using the second key 316. In state 408, the secure processor 112 enters and exits a sub-state 414, in which the second key register 344(2) is updated. The secure configuration registers 342(1)-342(M) may store an indication of the key state KEY_ST of the secure processor 112, indicating whether the re-encryption process is in progress and the key state KEY_ST of use of the first key 314 and the second key 316. In some examples, the secure configuration registers 342(1)-342(M) include a state register KEY_ST_REG (0:1) to indicate the key state KEY_ST. Thus, the key state register KEY_ST_REG (0:1) may indicate the key state KEY_ST has a value indicating one of states 402, 404, 406, and 408.

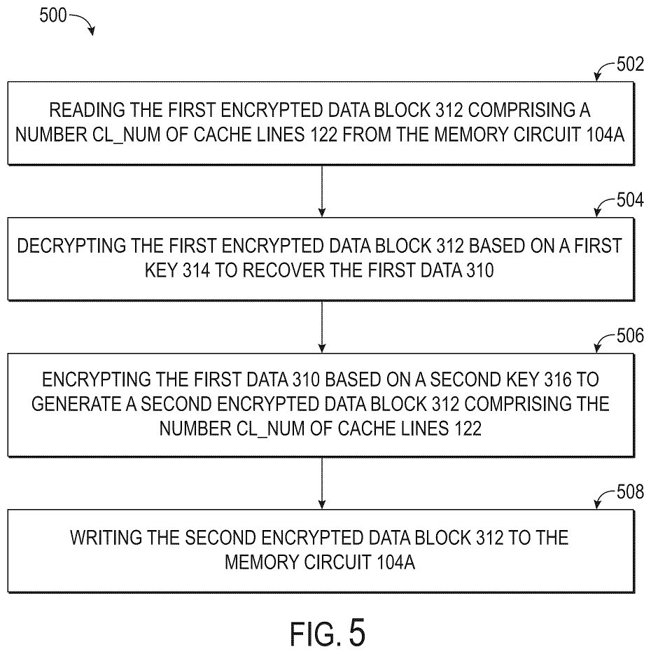

FIG. 5 is a flow chart of a memory interface circuit 200 configured to re-encrypt first data 310 in a first encrypted data block 312, the method comprising reading the first encrypted data block 312 comprising a number CL_NUM of cache lines 122 from the memory circuit 104A (block 502), decrypting the first encrypted data block 312 based on a first key 314 to recover the first data 310 (block 504), encrypting the first data 310 based on a second key 316 to generate a second encrypted data block 312 comprising the number CL_NUM of cache lines 122 (block 506), and writing the second encrypted data block 312 to the memory circuit 104A (block 508).

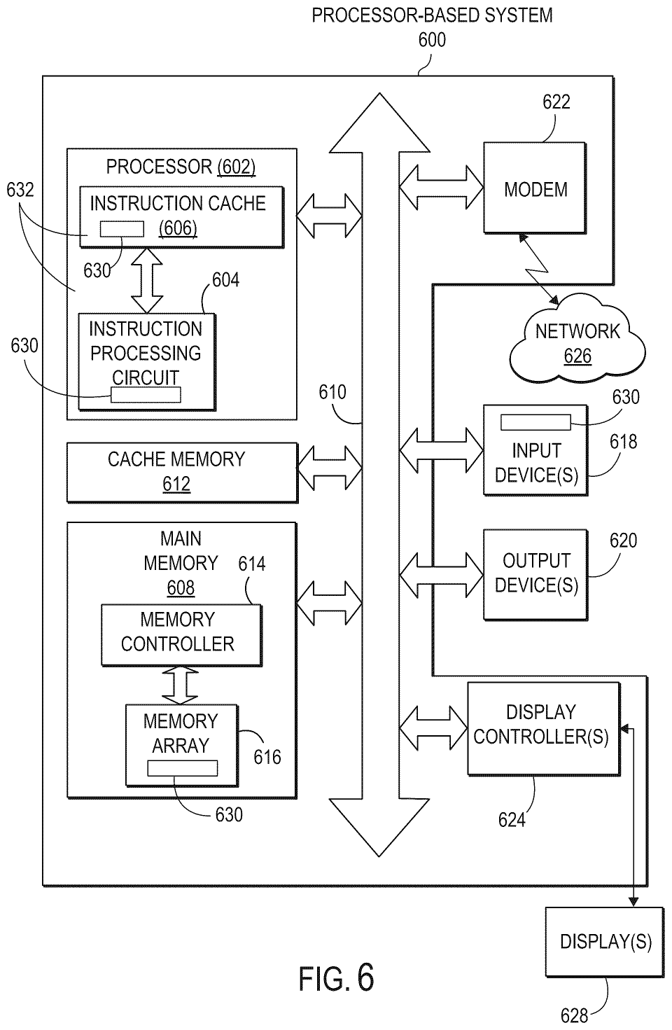

FIG. 6 is a block diagram of an exemplary processor-based system 600 that includes a processor 602 (e.g., a microprocessor), including an instruction processing circuit 604. The processor-based system 600 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer. In this example, the processor-based system 600 includes the processor 602. The processor 602 represents one or more general-purpose processing circuits, such as a microprocessor, central processing unit, or the like. More particularly, the processor 602 may be an EDGE instruction set microprocessor or other processor implementing an instruction set that supports explicit consumer naming for communicating produced values resulting from the execution of producer instructions. The processor-based system 600 may include a cloaking circuit 605 coupled to an electrical terminal of the processor 602 in an effort to reduce or prevent breaches of data security of the processor-based system 600.

The processor 602 is configured to execute processing logic in instructions for performing the operations and steps discussed herein. In this example, the processor 602 includes an instruction cache 606 for temporary, fast access memory storage of instructions accessible by the instruction processing circuit 604. Fetched or prefetched instructions from a memory, such as a main memory 608, over a system bus 610, are stored in the instruction cache 606. Data may be stored in a cache memory 612 coupled to the system bus 610 for low-latency access by the processor 602. The instruction processing circuit 604 is configured to process instructions fetched into the instruction cache 606 and process the instructions for execution. In some examples, the cloaking circuit 605 may additionally or alternatively be coupled to an electrical terminal of the system bus 610.

The processor 602 and the main memory 608 are coupled to the system bus 610 and can intercouple peripheral devices included in the processor-based system 600. As is well known, the processor 602 communicates with these other devices by exchanging address, control, and data information over the system bus 610. For example, the processor 602 can communicate bus transaction requests to a memory controller 614 in the main memory 608 as an example of a slave device. Although not illustrated in FIG. 6, multiple system buses 610 could be provided, wherein each system bus 610 constitutes a different fabric. In this example, the memory controller 614 is configured to provide memory access requests to a memory array 616 in the main memory 608. The memory array 616 is comprised of an array of storage bit cells for storing data. The main memory 608 may be a read-only memory (ROM), flash memory, dynamic random-access memory (DRAM), such as synchronous DRAM (SDRAM), etc. and/or static memory (e.g., flash memory, SRAM, etc.), as non-limiting examples.

Other devices can be connected to the system bus 610. As illustrated in FIG. 6, these devices can include the main memory 608, one or more input device(s) 618, one or more output device(s) 620, a modem 622, and one or more display controllers 624, as examples. The input device(s) 618 can include any type of input device, including but not limited to input keys, switches, voice processors, etc. The output device(s) 620 can include any type of output device, including but not limited to audio, video, other visual indicators, etc. The modem 622 can be any device configured to allow an exchange of data to and from a network 626. The network 626 can be any type of network, including but not limited to a wired or wireless network, a private or public network, a local area network (LAN), a wireless local area network (WLAN), a wide area network (WAN), a BLUETOOTH™ network, and the Internet. The modem 622 can be configured to support any type of communications protocol desired. The processor 602 may also be configured to access the display controller(s) 624 over the system bus 610 to control information sent to one or more displays 628. The display(s) 628 can include any type of display, including but not limited to a cathode ray tube (CRT), a liquid crystal display (LCD), a plasma display, etc.

The processor-based system 600 in FIG. 6 may include a set of instructions 630 to be executed by the processor 602 for any application desired according to the instructions. The instructions 630 may be stored in the main memory 608, the processor 602, and/or the instruction cache 606 as examples of a non-transitory computer-readable medium 632. The instructions 630 may also reside, completely or at least partially, within the main memory 608 and/or within the processor 602 during their execution. The instructions 630 may further be transmitted or received over the network 626 via the modem 622, such that the network 626 includes the computer-readable medium 632.

While the computer-readable medium 632 is shown in an exemplary embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or a computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips that may be referenced throughout the above description may be represented by voltages, currents, electromagnetic waves, magnetic fields, optical fields, or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A memory interface circuit, comprising:
a first interface configured to couple to a processing circuit;
a second interface configured to couple to a memory circuit; and
an encrypt/decrypt circuit;
wherein the memory interface circuit is configured to:
encrypt data stored in the memory circuit in response to a memory write transaction from the processing circuit;
decrypt encrypted data read from the memory circuit in response to a memory read transaction from the processing circuit; and
re-encrypt first data in a first encrypted data block stored in the memory circuit, the re-encrypt comprising:
reading the first encrypted data block comprising a first number of cache lines from the memory circuit;
decrypting, in the encrypt/decrypt circuit, the first encrypted data block based on a first key to recover the first data;
encrypting, in the encrypt/decrypt circuit, the first data based on a second key to generate a second encrypted data block comprising the first number of cache lines; and
writing the second encrypted data block to the memory circuit.

2. The memory interface circuit of claim 1, further comprising:
a plurality of configuration registers; and
a re-encryption circuit configured to:
receive configuration instructions directed to the plurality of configuration registers; and
for each configuration instruction of the configuration instructions received:
determine whether a source of the configuration instruction is authorized to access the plurality of configuration registers; and
in response to determining the source of the configuration instruction is authorized, access the plurality of configuration registers according to the configuration instruction.

3. The memory interface circuit of claim 2, the plurality of configuration registers configured to store a first number indicating the first encrypted data block comprises the first number of cache lines.

4. The memory interface circuit of claim 2, further configured to:
read the first encrypted data block from the memory circuit before writing the second encrypted data block to the memory circuit.

5. The memory interface circuit of claim 4, the plurality of configuration registers further configured to store a first memory address of a current cache line of the first number of cache lines in the first encrypted data block to be read, wherein:
the first number of cache lines are stored in sequential memory addresses in the memory circuit; and
the memory interface circuit is further configured to increment the first memory address each time one of the first number of cache lines of the first encrypted data block is read.

6. The memory interface circuit of claim 2, wherein:
the first encrypted data block comprises one of a plurality of encrypted data blocks; and
the memory interface circuit is further configured to re-encrypt the plurality of encrypted data blocks.

7. The memory interface circuit of claim 6, wherein:
the plurality of encrypted data blocks are stored in a range of memory addresses in the memory circuit; and
the plurality of configuration registers is configured to store a maximum memory address in the range of memory addresses.

8. The memory interface circuit of claim 6, wherein the plurality of configuration registers is further configured to store a start indication indicating to start re-encrypting the plurality of encrypted data blocks in the memory circuit.

9. The memory interface circuit of claim 8, further comprising a first key register and a second key register, wherein:
the first key register is configured to store the first key;
the second key register is configured to store the second key; and
in response to a first indication that re-encrypting the plurality of encrypted data blocks is complete, the re-encryption circuit is further configured to update the first key register to store an updated first key.

10. The memory interface circuit of claim 9, further configured to, in response to a second indication that re-encrypting the plurality of encrypted data blocks is complete, re-encrypt the plurality of encrypted data blocks based on the updated first key and update the second key register to store an updated second key.

11. A processor-based system comprising:
at least one processing circuit;
a memory circuit; and
a memory interface circuit, comprising;
an encrypt/decrypt circuit;
a re-encryption circuit comprising:
a first interface configured to couple to the at least one processing circuit; and
a second interface configured to couple to the memory circuit;
wherein the memory interface circuit is configured to:
encrypt data stored in the memory circuit in response to a memory write transaction from the at least one processing circuit;
decrypt encrypted data read from the memory circuit in response to a memory read transaction from the at least one processing circuit; and
re-encrypt first data in a first encrypted data block stored in the memory circuit, the re-encrypt comprising:
reading the first encrypted data block comprising a first number of cache lines from the memory circuit;
decrypting, in the encrypt/decrypt circuit, the first encrypted data block based on a first key to recover the first data;
encrypting, in the encrypt/decrypt circuit, the first data based on a second key to generate a second encrypted data block comprising the first number of cache lines; and
writing the second encrypted data block to the memory circuit.

12. The processor-based system of claim 11, the memory interface circuit further comprising:
a secure processor; and
a secure interface coupled to the secure processor and the memory interface circuit;
wherein:
the first encrypted data block comprises one of a plurality of encrypted data blocks in a configured range of memory addresses in the memory circuit; and
the memory interface circuit is further configured to start re-encrypting each block of the plurality of encrypted data blocks in response to a first configuration instruction received from the secure processor on the secure interface.

13. The processor-based system of claim 12, wherein the secure processor is configured to program a configuration register to indicate the configured range of memory addresses.

14. The processor-based system of claim 13, wherein the secure processor is configured to:
transmit a second configuration instruction to start re-encrypting each block of the plurality of encrypted data blocks within a configurable time window; and
configure the time window to be long enough to re-encrypt every block of the plurality of encrypted blocks in the configured range of memory addresses.

15. The processor-based system of claim 14, wherein:
the memory interface circuit is configured to:
receive memory access transactions from the at least one processing circuit; and
access the memory circuit in response to the memory access transactions; and
the secure processor is configured to:
determine an idle time of the memory interface circuit between receiving consecutive memory access transactions; and
adjust the time window based on the idle time.

16. The processor-based system of claim 12, wherein the memory interface circuit further comprises a plurality of configuration registers and the memory interface circuit is further configured to:
receive a configuration instruction on the secure interface to access the plurality of configuration registers;
determine whether a source of the configuration instruction has authorization to access the plurality of configuration registers; and
in response to determining the source of the configuration instruction has authorization, access the plurality of configuration registers according to the configuration instruction.

17. A method of a memory interface circuit to re-encrypt first data in a first encrypted data block in a memory circuit, the method comprising:
reading the first encrypted data block comprising a first number of cache lines from the memory circuit;
decrypting the first encrypted data block based on a first key to recover the first data;
encrypting the first data based on a second key to generate a second encrypted data block comprising the first number of cache lines; and
writing the second encrypted data block to the memory circuit.

18. The method of claim 17, further comprising:
receiving, in a re-encryption circuit, configuration instructions directed to a plurality of configuration registers; and
for each configuration instruction of the configuration instructions received:
determining whether a source of the configuration instruction is authorized to access the plurality of configuration registers; and
in response to determining the source of the configuration instruction is authorized, accessing the plurality of configuration registers according to the configuration instruction.

19. The method of claim 17, further comprising re-encrypting a plurality of encrypted data blocks comprising the first encrypted data block.

20. The method of claim 19, further comprising:
starting to re-encrypt the plurality of encrypted data blocks in the memory circuit in response to a start indication stored in the plurality of configuration registers.
